(19) United States
(12) Patent Application Publication
(10) Pub. No.: US 2009/0184153 A1
(43) Pub. Date: Jul. 23, 2009

(54) Method of Producing a Welded Joint

(75) Inventors: Armin Eberlein, Klosterlechfeld (DE); Albert-Valentin Schneider, Muenchen (DE); Dirk Eckart, Wolfratshausen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/084,070

(22) PCT Filed: Oct. 17, 2006
(86) PCT No.: PCT/DE2006/001831

§ 371 Date: Feb. 27, 2009

(30) Foreign Application Priority Data
Oct. 26, 2005 (DE) 10 2005 051 229.1

(51) Int. Cl. B23K 31/02

(52) U.S. Cl. 228/119; 228/164; 228/174

(57) ABSTRACT

A method of producing a welded joint between components of a turbomachine is described, in particular for the repair of components, wherein components are welded to one another along common edges in such a way that a pocket-like recess is incorporated in a first component, in particular in a replacement part, with which recess the first component is slipped onto a second component, in particular a component to be repaired, such that the second component bears with an end edge on a base of the pocket-like recess, and that the first component and the second component are then welded to one another. According to the invention, at least one cutout is incorporated in the first component in addition to the pocket-like recess in order to minimize heat transfer and the formation of component deformations during the subsequent welding of the components.

The present invention relates to a method for producing a welded joint for components of a turbine-type machine, in particular for repairing components, as recited in the preamble of claim 1.

The German Patent DE 42 25 443 C2 describes a method for producing a welded joint for components of a turbine-type machine, in particular for use in repairing a blade of a gas turbine blade; to this end, a damaged portion being removed from the blade of the gas turbine blade and being replaced by a replacement part. The replacement part is also referred to as a patch. In accordance with the German Patent DE 42 25 443 C2, a pocket-like recess is introduced into the replacement part, the pocket-like recess facilitating placement of the replacement part on the blade of the gas turbine blade to be repaired. The German Patent DE 42 25 443 C2 discusses filling a gap, which forms in the area of the pocket-like recess between the replacement part and the blade of the gas turbine blade to be repaired, with metal powder in order to weld the two components together. Here defects can form in the weld seam, and internal stresses can likewise be introduced into the components that are to be joined together.

Against this background, an object of the present invention is to devise a novel method for producing a welded joint for components of a turbine-type machine, in particular for use in repairing a component. This objective is achieved by a method as set forth in claim 1. In accordance with the present invention, in addition to the pocket-like recess, at least one cutout is introduced into the first component in order to minimize a dissipation of heat and the development of component deformations during the subsequent process of welding the components together.

Accordingly, besides the pocket-like recess, the present invention also provides that a material cutout or a plurality of material cutouts be introduced into the first component that is preferably being used as a replacement part. By introducing the cutout, respectively the cutouts, into the first component, it is possible to prevent an uneven temperature distribution along the weld seam to be formed. Accordingly, the formation of defects at the weld seam is minimized. In addition, the development of internal stresses and thus of component deformations is minimized during the process of welding the components together.

A first cutout is preferably introduced into a side wall of the first component opposite the pocket-like recess, this first cutout having a step-shaped or rounded contour and extending essentially in the direction of a weld seam to be formed between the components.

Second cutouts are preferably introduced into the side walls of the first component bounding the pocket-like recess, these second cutouts having a slit- or slot-type contour and extending essentially transversely to the direction of the weld seam to be formed.

One advantageous refinement of the present invention provides for a pocket-like recess, whose contour is adapted to the contour of an end portion of the second component to be inserted into the same, to be introduced into the first component in such a way that when the first component is slipped onto the second component, a gap of such a minimal size is formed between the pocket-like recess of the first component and the end portion of the second component that the components rest flush against one another in the region of the pocket-like recess. This makes it possible for the quality of the welded joint to be further enhanced as compared to the method known from the related art. In particular, this prevents defects from forming and internal stresses from being introduced into the components that are to be joined together.

Preferred embodiments of the present invention are derived from the dependent claims and from the following description. The present invention is described in greater detail in the following on the basis of exemplary embodiments, without being limited thereto. Reference is made to the drawing, whose:

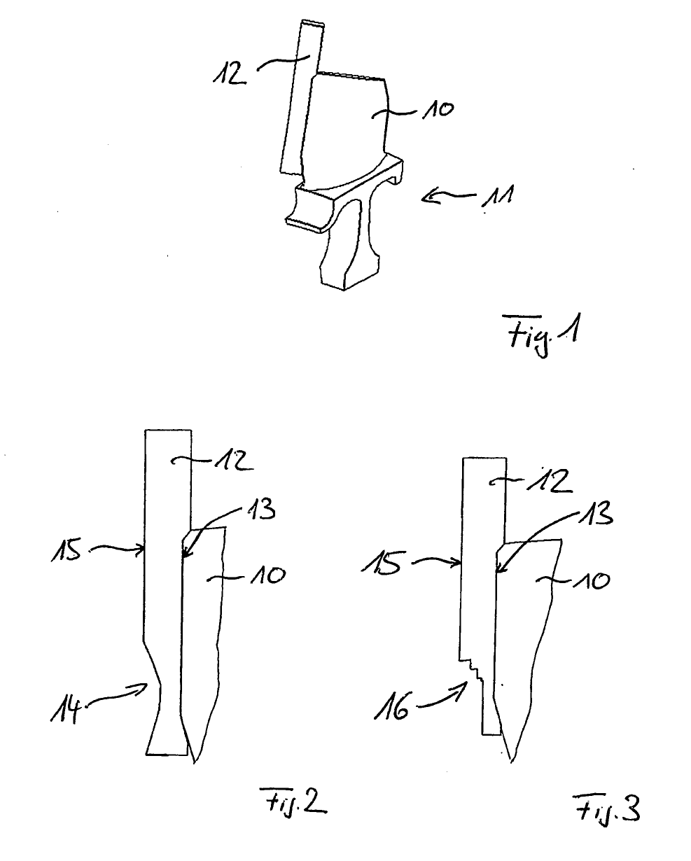

FIG. 1: shows a gas turbine blade to be repaired, together with a replacement part to be welded to a blade of the same;

FIG. 2: is a detail of the arrangement according to FIG. 1, in accordance with a first exemplary embodiment of the present invention;

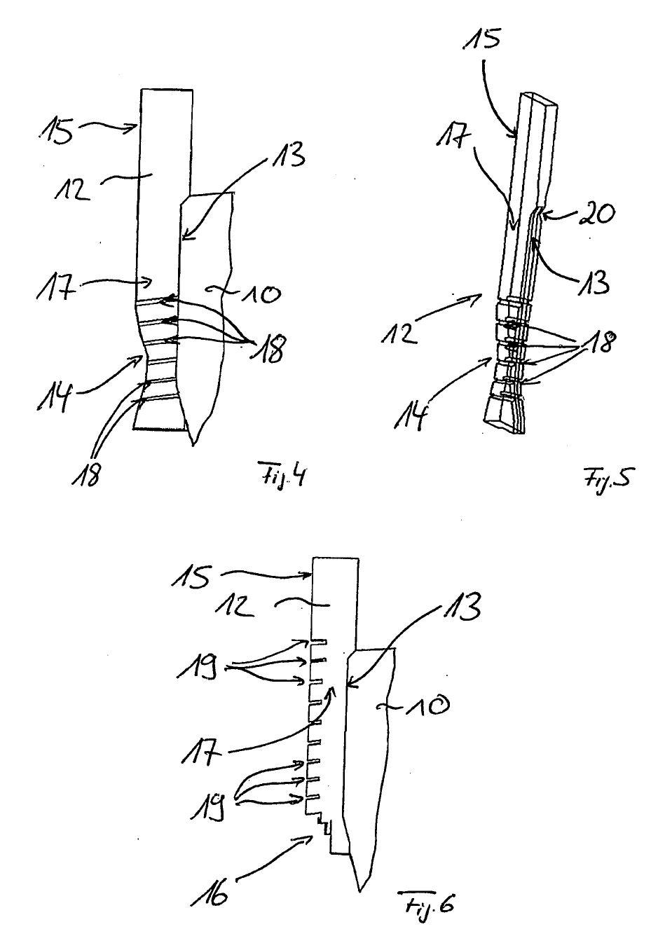

FIG. 3: is a detail of the arrangement according to FIG. 1, in accordance with a second exemplary embodiment of the present invention;

FIG. 4: is a detail of the arrangement according to FIG. 1, in accordance with a third exemplary embodiment of the present invention;

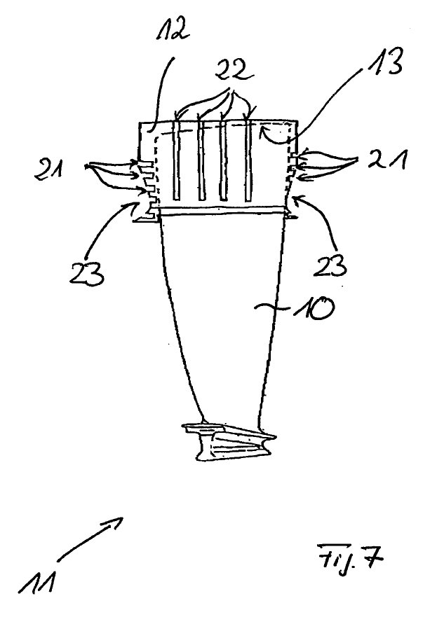

FIG. 5: shows the replacement part of FIG. 4 in a perspective view;

FIG. 6: is a detail of the arrangement according to FIG. 1, in accordance with another exemplary embodiment of the present invention; and

FIG. 7: shows another gas turbine blade to be repaired, together with a replacement part to be welded to a blade of the same.

The present invention is directed to a method for producing a welded joint for components of a turbine-type machine. The method is used, in particular, for repairing components of gas turbine blades in the area of one blade; to this end (see FIG. 1), a damaged portion being removed or separated from a blade 10 of a gas turbine blade 11 to be repaired and being replaced by a replacement part 12 by welding on of the same. The present invention is described in the following for this preferred application, it being noted at this point, however, that the method according to the present invention may be used for welding together any given components.

To repair a gas turbine blade 11 using the method according to the present invention, as already mentioned, a damaged blade portion is first separated from blade 10 of gas turbine blade 11 to be repaired. This damaged blade portion is to be replaced by a replacement part 12, also referred to as a patch, by welding replacement part 12 to remaining blade 11. Once the components have been welded, a surface machining of at least replacement part 12 is carried out in order to produce surfaces having the desired aerodynamic properties on blade 10.

Remaining blade 11 is measured, at least a section thereof, namely at least in the area of a separation region formed by separating the damaged blade portion; as a function thereof, a pocket-like recess 13 (see FIG. 5) being introduced into replacement part 12. Pocket-like recess 13 is adapted in its contour to the separation region of blade 10 that is formed on blade 10 following separation of the damaged blade portion. Replacement part 12 is slipped via this pocket-like recess 13 onto the separation region of blade 10 and, in fact, in such a way that an end edge or separation edge of the blade rests on a base of pocket-like recess 13 of replacement part 12. In this context, the contour of pocket-like recess 13 is adapted to the contour of the separation region of blade 10 in such a way that a gap of minimal size is formed between pocket-like recess 13 of replacement part 12 and blade 11 of gas turbine blade 10 and, in fact, in such a way that replacement part 12 and blade 10 rest flush against one another in the area of pocket-like recess 13. Replacement part 12, as well as blade 10 are then welded together without the use of any additional welding material, in particular welding powder.

Pocket-like recess 13 introduced into the replacement part may be contoured to have an essentially uniform material thickness along a weld seam line, along which replacement part 12, as well as blade 10 are joined together. This allows substantially constant welding parameters to be used when welding along the weld seam line.

Recesses in the form of slits and/or slots and/or steps and/or round contours and/or bores are introduced into replacement part 12, namely into the external surfaces of side walls thereof. This makes it possible to minimize a dissipation of heat from components 11, 12 to be joined together and to maintain a substantially constant process temperature for welding during the entire welding process. By introducing the slits and/or slots and/or steps and/or round contours and/or bores into replacement part 12, it is possible to prevent replacement part 12 from being deformed during the welding process. This enhances the attainable welding quality.

In the exemplary embodiment of FIG. 2, in addition to pocket-like recess 13, a cutout 14 is introduced into the first component being used as replacement part 12, cutout 14 being introduced into the same at a side wall 15 of replacement part 12 opposite pocket-like depression 13. In the exemplary embodiment of FIG. 2, cutout 14 has been given a rounded, in particular circular segment-shaped contour. Accordingly, cutout 14 has a rounded design in the exemplary embodiment of FIG. 2. Cutout 14 extends substantially in the radial direction of blade 10, respectively of gas turbine blade 11, as well as in the direction of a weld seam to be formed between blade 10 and replacement part 12. In accordance with FIG. 2, cutout 14 is assigned to a radially inner portion of side wall 15.

In the exemplary embodiment of FIG. 3, a cutout 16, which is likewise introduced into side wall 15 of replacement part 12 opposite pocket-like recess 13, in contrast to cutout 14 of the exemplary embodiment of FIG. 2, does not have a rounded contour, but rather a step-shaped or stepped contour. Cutout 16, in turn, extends substantially in the radial direction of blade 10, respectively of gas turbine blade 11, as well as in the direction of a weld seam to be formed between blade 10 and replacement part 12 and, in accordance with FIG. 3, is assigned to a radially inner portion of side wall 15.

In the exemplary embodiment of FIGS. 4 and 5, in addition to rounded recess 14 that is formed in the area of a side wall 15 of replacement part 12 opposite recess 13, other recesses 18 having a slit- or slot-type contour are introduced into replacement part 12 in the area of mutually opposing side walls 17 bounding pocket-like recess 13. In the exemplary embodiment of FIGS. 4 and 5, slit- or slot-type recesses 18 extend substantially in the axial direction of blade 10 of gas turbine blade 11 to be repaired and thus substantially transversely to a weld seam to be formed between blade 10 and replacement part 12.

In addition, as may be inferred from FIG. 5, due to the additional material cutouts having a preferably rounded contour, the replacement part of the exemplary embodiment of FIGS. 4 and 5 has a constricted shape at mutually opposing side walls 17 at a radially inner portion of the same, the slit- or slot-type recesses 18 being exclusively formed on this radially inner, constricted portion of mutually opposing side walls 17. In contrast to the exemplary embodiment of FIGS. 4 and 5, slit-type recesses 18 may also extend over the entire height of recess 13, as well as over the entire radial extent of replacement part 12.

In the exemplary embodiment of FIGS. 4 and 5, another cutout 20 is provided at a radially outer portion of pocket-like recess 13, in order to avoid deformations in the critical bypass region leading to a blade tip of blade 11.

FIG. 6 shows another exemplary embodiment of the present invention. In the exemplary embodiment of FIG. 6, a cutout 16 having a step-shaped or stepped contour, on the one hand, and a plurality of slit- or slot-type cutouts 19, on the other hand, are introduced into replacement part 12. In the exemplary embodiment of FIG. 6, slit- or slot-type recesses 19 are introduced into side wall 15 of replacement part 12 facing opposite pocket-like recess 13. In accordance with FIG. 6, slit- or slot-type recesses 19 extend essentially in the circumferential direction of gas turbine blade 11 to be repaired, respectively of blade 10 thereof, and in fact over the entire radial extent of pocket-like recess 13.

In the exemplary embodiments of FIG. 1 through 6, replacement part 12 extends exclusively over the region of one edge of blade 10 of gas turbine blade 11 to be repaired, namely either in the region of a leading edge or in the region of a trailing edge thereof. On the other hand, FIG. 7 shows an exemplary embodiment where replacement part 12 extends over the entire axial length of blade 10 of gas turbine blade 11 to be repaired, namely between leading edge and trailing edge thereof. It is self-evident that replacement part 12 of the exemplary embodiment of FIG. 7 also has a pocket-like recess 13. A plurality of slit- or slot-type cutouts are introduced into replacement part 12 of the exemplary embodiment of FIG. 7, namely first slit-type cutouts 21 adjacently to leading edge, respectively trailing edge, and second slit-type cutouts 22 adjacently to a blade tip, first cutouts 21 extending substantially circumferentially and second cutouts 22 extending substantially radially. In addition, round-contoured cutouts 23, which extend substantially in the radial direction of blade 10, respectively of gas turbine blade 11, are introduced into replacement part 12, both adjacently to the leading edge, as well as adjacently to the trailing edge. Second slit-type cutouts 22 and round-contoured cutouts 23 extend substantially transversely to the direction of a weld seam to be formed. On the other hand, first slit-type cutouts 21 extend substantially in the direction of the weld seam to be formed. Cutouts 21, 22 and 23 are introduced into the side walls of replacement part 12 bounding the pocket-like recess.

It may be provided in a welding operation for components 11, 12, which are to be joined together, to be preheated to a process temperature with the aid of a heat source, prior to the actual welding process; during the welding, the two components 11, 12 likewise being maintained at the process temperature through the use of a heat source. Upon termination of the welding process, the components that have been joined together may also undergo a postweld heating. As a heat source, an inductive heat source, an electrical heating spiral, or a laser may be used, for example.

As already mentioned, prior to formation of the weld seam, replacement part 12 is slipped via pocket-like recess 13 onto blade 10 to be repaired, from which the damaged blade portion had been removed. Once it has been slipped on, replacement part 12 may be positioned on blade 10 with the aid of tack welds. Specially designed retaining devices may also be used to arrange replacement part 12 on blade 10 and hold it in place during welding. Run-on, as well as runoff plates may also be integrated in replacement part 12 for the weld seam.

If the replacement part is a patch that extends between a leading edge, respectively a trailing edge of the blade and a blade tip thereof, the weld seam may then extend in any desired manner, namely, on one side, from the leading edge, respectively the trailing edge, to the blade tip or also the other way around, from the blade tip to the leading edge or trailing edge of the blade.

The method according to the present invention makes it possible to optimize the process of using a welded joint to join components together. In particular, it allows constant welding parameters to be used when producing welded joints on components of a gas turbine. The formation of defects, as well as the introduction of internal stresses into the components that are to be joined together are minimized during the welding process. Overall, therefore, the welding quality may be enhanced.

1-13. (canceled)

14: A method for producing a welded joint for components of a turbine-type machine, comprising:
introducing a pocket-like recess into a first component;
introducing a first component onto a second component via the pocket like recess;
engaging the second component by an end edge on a base of the pocket-like recess;
subsequently welding together the first component and the second component along shared edges;
introducing at least one additional cutout into the first component in order to minimize heat dissipation and the development of component deformations during the subsequent welding together of the first and second components.

15: The method as recited in claim 14, wherein the first component is a replacement part.

16: The method as recited in claim 14, wherein the second component is a component to be repaired.

17: The method as recited in claim 14, wherein the step of introducing at least one additional cutout comprises introducing a first cutout into a side wall of the first component opposite the pocket-like recess, the first cutout having a stepped or rounded contour.

18: The method as recited in claim 17, wherein the first cutout extends essentially in the direction of a weld seam to be formed between the components.

19: The method as recited in claim 17, wherein the step of introducing at least one additional cutout further comprises introducing a second cutout into at least one side wall of the first component bounding the pocket-like recess, the second cutout having a slit- or slot-type contour.

20: The method as recited in claim 14, wherein the step of introducing at least one additional cutout further comprises introducing a first cutout into at least one side wall of the first component bounding the pocket-like recess, the first cutout having a slit- or slot-type contour.

21: The method as recited in claim 19, wherein the second cutout extends essentially transversely to the direction of the weld seam to be formed.

22: The method as recited in claim 14, wherein the first component has a constricted shape, and the first component has cutouts at mutually opposing side walls bounding the pocket-like recess and extending essentially transversely to the pocket-like recess.

23: The method as recited in claim 14, wherein
the first component is a replacement part;
the second component is a gas turbine blade; and
the step of introducing at least one additional cutout comprises introducing a first cutout essentially extending in the radial direction of the blade and introducing a second cutout essentially extending in the axial direction and/or in the circumferential direction of the blade.

24: The method as recited in claim 14, wherein the step of introducing at least one additional cutout comprises introducing cutouts having a slit- or slot-type contour and round-contoured cutouts into a plurality of side walls of the first component bounding the pocket-like recess.

25: The method as recited in claim 14, wherein
the step of introducing a pocket-like recess into a first component comprises introducing the pocket-like recess into the first component in such a way that when a first component is inserted onto a second component, a gap is formed of minimal dimensions between the pocket-like recess of the first component and the end portion of the second component such that the first and second components rest flush against one another in the region of the pocket-like recess; and
the step of introducing a pocket-like recess into a first component further comprises adapting a contour of the pocket-like recess to the contour of an end portion of a second component;

26: The method as recited in claim 14, wherein the step of subsequently welding together the first component and the second component is performed without the use of any additional welding material.

27: The method as recited in claim 14, the step of introducing a pocket-like recess into a first component comprises contouring the pocket-like recess to have an essentially uniform material thickness along a weld seam line,

28: The method as recited in claim 14 wherein the step of welding together the first component and the second component along shared edges comprises using substantially constant welding parameters for welding along the weld seam line.

29: The method as recited in claim 14, wherein, prior to the step of welding together the first component and the second component along shared edges:
preheating the first and second components to a process temperature at least in the region of the weld seam line;
heating the first component and second component during the step of welding together to maintain both the first and second components at a process temperature, at least in the region of the weld seam line.

30: A method for repairing components of a gas turbine blade comprising:
separating a blade portion to be replaced by a replacement part;
measuring a section of a remaining blade;
incorporating a pocket-like recess into the replacement part; and
forming a welded joint as recited in claim 14 between a first component and a second component.

31: The method as recited in claim 30, wherein the first component is a replacement part.

32: The method as recited in claim 30, wherein the second component is a component to be repaired.

33: The method as recited in claim 32, wherein the second component is a gas turbine blade.
